(19) United States
(12) Patent Application Publication
(10) Pub. No.: US 2013/0124288 A1
(43) Pub. Date: May 16, 2013

(54) Personal digital cashier with the coupon locator

(71) Applicants: Jamaal Carter, Plainfield, IL (US); George Jacob, Roselle, IL (US); Myleson M. Collins, Chicago, IL (US); Samir I. Patel, Chicago, IL (US); Filipp Kirik, Prairie View, IL (US)

(72) Inventors: Jamaal Carter, Plainfield, IL (US); George Jacob, Roselle, IL (US); Myleson M. Collins, Chicago, IL (US); Samir I. Patel, Chicago, IL (US); Filipp Kirik, Prairie View, IL (US)

(21) Appl. No.: 13/694,042

(22) Filed: Oct. 22, 2012

Related U.S. Application Data
(60) Provisional application No. 61/627,973, filed on Oct. 22, 2011.

(51) Int. Cl. G06Q 30/02

(52) U.S. Cl. CPC G06Q 30/0222
USPC 705/14.23

(57) ABSTRACT

An integrated purchasing system for mobile devices with coupon and discount locating functionality that enables a shopper to obtain discounts, coupons, and to purchase the goods and services of their choice from a retail store without having to stand in a checkout line. The Personal Digital Cashier with the Coupon Locator also provides the shopper with the ability to determine which store(s) in the shoppers selected proximity have the best deals or discounts on the items desired for purchase, as well as to shop online using their Personal Digital Cashier with the Coupon Locator account.

### CROSS REFERENCE TO RELATED APPLICATIONS

This patent application claims the benefit, under 35 U.S.C. 119(e), of U.S. Provisional Patent Application Ser. No 61/627,973, entitled “Personal Digital Cashier with the Coupon Locator” to Jamaal Carter, et. al and filed on Oct. 22, 2011, which is fully incorporated herein by reference as describing and illustrating subject matter (in part(s) or in its entirety) that can be practiced with the subject matter disclosed herein.

### FIELD OF THE INVENTION

The present invention relates generally to electronic shopping systems in general, and more particularly to portable electronic shopping systems enabling a completed purchase transaction including discount and coupon handling, as well as payment completion and confirmation.

### BACKGROUND OF THE INVENTION

Today's retail stores have made tremendous strides in improving the shopping experience for the modern shopper. In response to tremendous pressures from online retailers offering virtual shopping from anywhere the internet can be accessed, retail stores have taken steps to improve their pricing and make their deals more attractive to shoppers, as well as increased their efforts to reduce the amount of time shoppers spend waiting in line to purchase their desired items. Sales flyers, television commercials, and even email advertisements are all used to attract customers into their stores to purchase the advertised deals, in the hopes that once the shopper has entered the store, they will make additional purchases as well as the advertised deals.

A retailer's ability to speed up the flow of customers through the checkout line or to reduce the cost of each shoppers purchase transaction is critical to the success of their business. The introduction of bar codes into the checkout process allowed for the scanning of the bar code on each item by a point of sale machine that read the bar code and added the items cost to the cumulative total cost of the shoppers items. Although scanning each item at a checkout register is faster than manually entering each price, the sequential scanning of each item for each customer by a cashier can take a long time and create long lines of customers awaiting their turn to be checked out.

Prior art devices for improving the shoppers wait time and overall shopping experience include self-checkout lanes, and price scanners placed strategically throughout the store. Many grocery stores have used self-checkout lanes that automate the checkout process, but may not necessarily decrease the amount of time waiting in line to check out. Standing in a self-checkout lane behind an inexperienced or “technology-challenged” shopper is just as time consuming and frustrating as standing in the long lines waiting for the cashier to check you out. Price scanners are helpful, but are not usually in close enough proximity to where the shopper is at the time to be fully effective in reducing their time spent in the store.

### SUMMARY OF THE INVENTION

The Personal Digital Cashier with the Coupon Locator provides a system and method for enabling a shopper to enhance their in-store experience through the use of a mobile device and related application system to complete the shopping process without having to wait in line at the cashier or the self-checkout register. The Personal Digital Cashier also has a coupon location feature that uses global positioning satellite (GPS) based technology to notify the shopper of the best discounts, specials and deals available at the retail stores within the proximity selected by the shopper. Using combined features of the Personal Digital Cashier with the Coupon Locator system would allow a shopper to locate the best deals around, apply any discounts or coupons that were located, and then to complete the purchase transaction for their items without waiting in line to check out.

### DESCRIPTION OF THE PREFERRED EMBODIMENT

While the invention will be described in connection with a preferred embodiment, it will be understood that the preferred embodiment is not intended to limit the invention to this embodiment. On the contrary, it is intended as an example of the invention, which has various alternative embodiments, modifications, and equivalents that are all included within the spirit and scope of the invention.

In a preferred embodiment, the Personal Digital Cashier with the Coupon Locator can be installed and used on any smart device or smart phone, including the Iphone, android, and blackberry platforms. Once installed and activated, the shopper would be given the option to view a tutorial on how to use the PDC system, then taken to the systems home screen where various usage options can be selected, including starting a shopping cart, or scanning the UPC code of an item to be purchased. Once all items the shopper desires to purchase have been scanned and placed in their cart, and the associated discounts and located coupons applied to the selected items, the checkout option can be selected, and the payment completed from their electronic account associated with the PDC system that is both interest bearing and placed with an FDIC insured financial institution. An electronic receipt will then be generated by the system and stored on the shopper's personal webpage that logs all activity of their purchases and transactions with the PDC system. The retailer will have received an electronic confirmation of the completed purchase on their inventory and accounting systems.

### DESCRIPTION OF ALTERNATE EMBODIMENTS

In an alternative embodiment, when the Personal Digital Cashier with the Coupon Locator is being used in a store that does not have the ability to confirm electronic purchasing; the PDC system can present the promo codes or digital coupons for the items being purchased so that the appropriate discounts can be taken off by the stores cashier.

In another embodiment, the Personal Digital Cashier with the Coupon Locator communicates with the retail stores RFID exiting aisle technology to confirm that all of the items in the shoppers cart have been paid for, and causes the deactivation of the RFID tags on the purchased items.

In another embodiment, the Personal Digital Cashier with the Coupon Locator can be pre-loaded on mobile devices when they are purchased so that at the point of sale for the mobile device, the Personal Digital Cashier with the Coupon Locator can be used immediately for shopping.

In another embodiment, the Personal Digital Cashier with the Coupon Locator can be used to complete purchases and redeem coupons or discounts from online retailers as well.

In another embodiment, the Personal Digital Cashier with the Coupon Locator can receive input from various other input sources including a near field communication interface, camera, or scanner.

In another embodiment, the PDC with the Coupon Locator receives discounts, specials and deals from retailers all around the world who have uploaded the same discounts, specials and coupons seen in their printed advertising and sales papers into the PDC system. Based upon the shoppers' location, and established preferences, the PDC system will notify the shopper of the best discounts, specials, and coupons to maximize their savings.

In another embodiment, the PDC with the Coupon Locator communicates with the retailer's inventory and purchasing system to confirm a successful purchase transaction so that their electromagnetic, radio-frequency, acoustic-magnetic, or other anti-theft tag and alarm systems are deactivated for the purchased items.

In yet another embodiment the Personal Digital Cashier with the Coupon Locator system functionality can be accessed and managed from the shoppers PDC website. The Personal Digital Cashier with the Coupon Locator website allows each shopper an additional means of accessing their account information, the latest news and announcements from the system and any affiliated stores, as well as the latest coupons and deals for their nearby or favorite stores.

Although the descriptions above contain much specificity, they should not be construed as limiting the scope of the invention, but as merely providing illustrations of some of the presently preferred embodiments of the Personal Digital Cashier with the Coupon Locator. Many other variations and modifications will be apparent to those skilled in the art, including the ability to receive input via various means including.

### OBJECTS AND ADVANTAGES

It is a general object of this invention to provide a portable system for completing a shopping experience without waiting in a checkout line.

It is also an object of this invention to provide a shopper with the ability to complete a purchase transaction without carrying cash or credit cards.

It is another object to provide a means of comparison shopping without driving around to various stores or searching through endless sales papers.

A further object of the invention is to enable shoppers to use coupons, discounts and specials without having to carry around a wallet full of coupons.

Another object of the invention is to provide a purchasing system where the payment mechanism is integrated into the system, and does not require a third party payment system or account.

Other additional objects and advantages of the invention will become apparent upon reading the following detailed description and upon reference to the drawing figures.

### BRIEF DESCRIPTION OF DRAWINGS

FIG. 1 is a view of the shoppers' initial welcome screen.

FIG. 2 is a view of the shoppers' home screen.

FIG. 3 is a view of the shoppers' active cart while shopping.

FIG. 4 is a view of all of the shoppers open carts.

FIG. 5 is a view of the shoppers' stores.

FIG. 6 is a view of the shoppers' available deals.

FIG. 7 is a view of the options screen.

FIG. 8 is a view of the store home screen.

FIG. 9 is a view of the screen shown while awaiting a cart for validation.

FIG. 10 is a view of the screen shown when a cart is ready for validation.

FIG. 11 is a view of the screen when a cart is in the process of being validated.

FIG. 12 is a view of the screen shown after selecting Carts from the navigation menu.

FIG. 13 is a view of the store options screen.

FIG. 14 is a process flow diagram for a process when a shopper is near or in a store.

FIG. 15 is a process flow diagram for the shopping and the purchase processes.

FIG. 16 is a process flow diagram for system behavior when a shopper is accessing deal information.

FIG. 17 is a system flow diagram for processing a shopper's cart that is ready for validation.

FIGS. 18-23 illustrate some of the various screens displayed on the shopper's personal website.

FIGS. 24-29 illustrate some of the pages displayed on the administrator's website for store and/or system maintenance and management.

### DETAILED DESCRIPTION OF DRAWINGS

Certain embodiments of the present invention provide system and method for using a portable smart device to complete a purchase transaction. In some embodiments, the system can receive a coupon, deal or special from stores within the shoppers selected vicinity to be used/redeemed at the time of purchase.

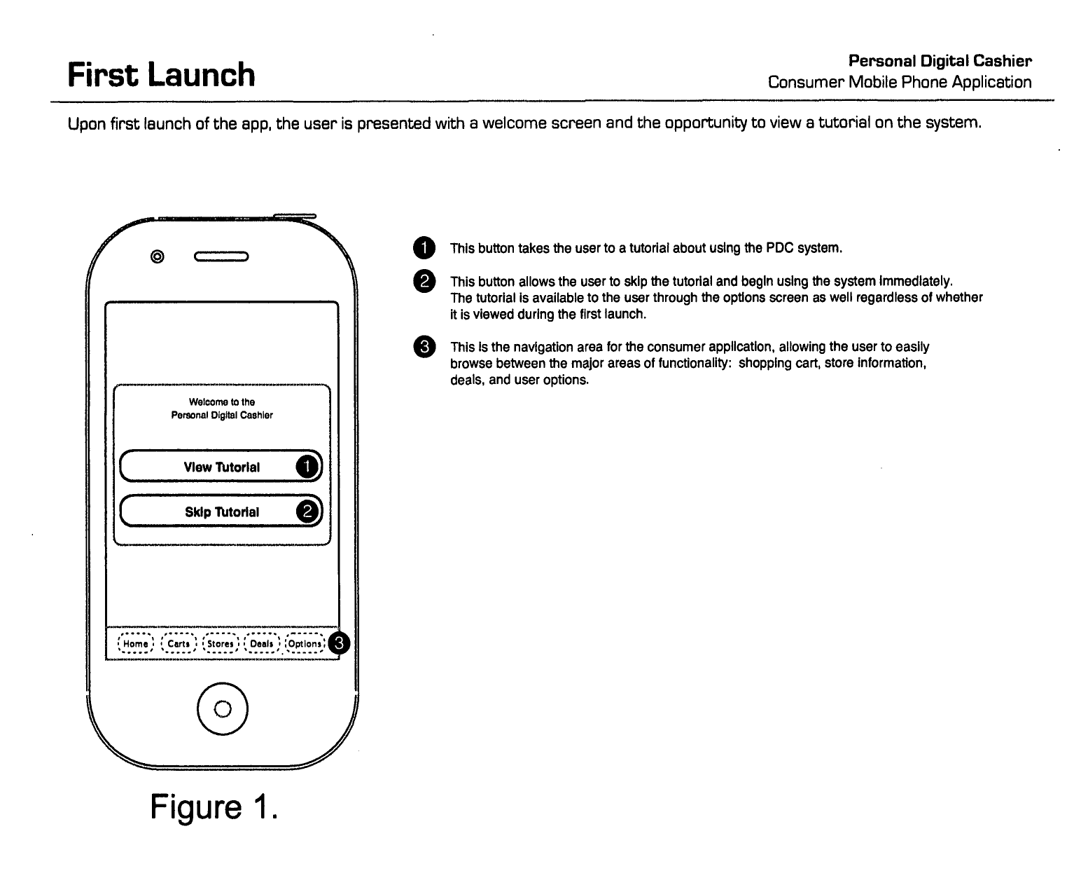

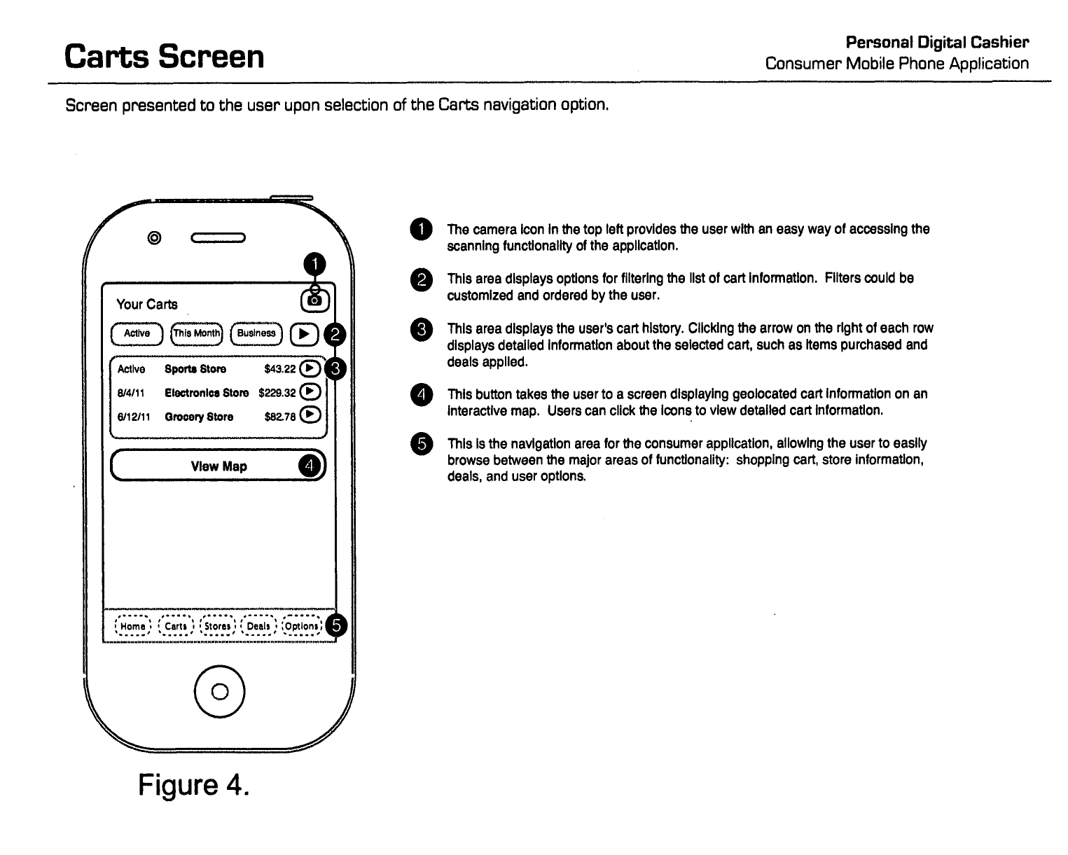

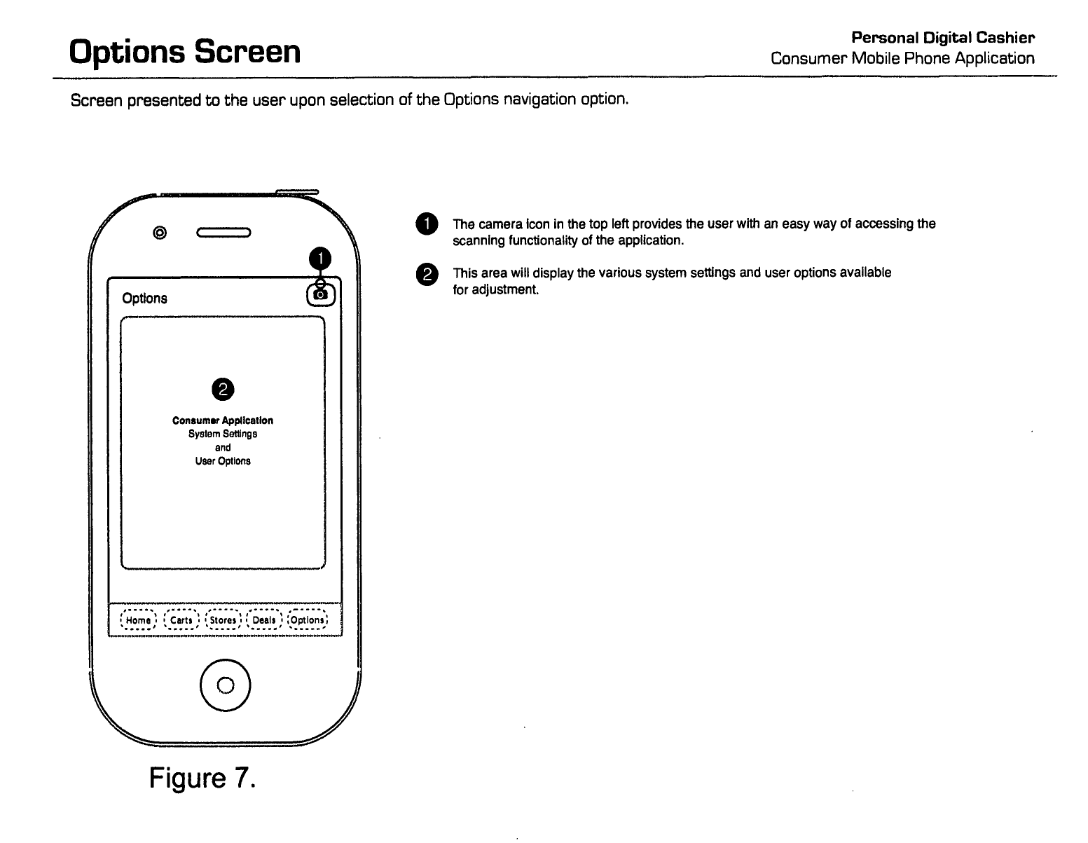

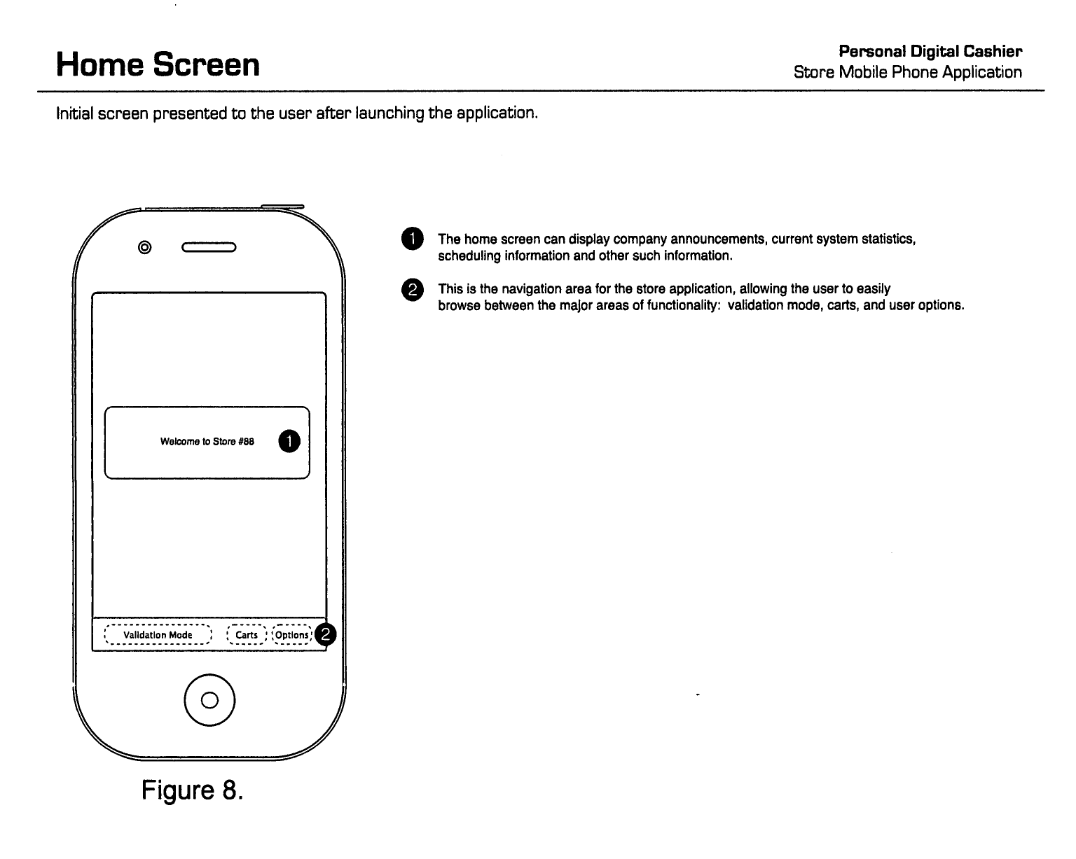

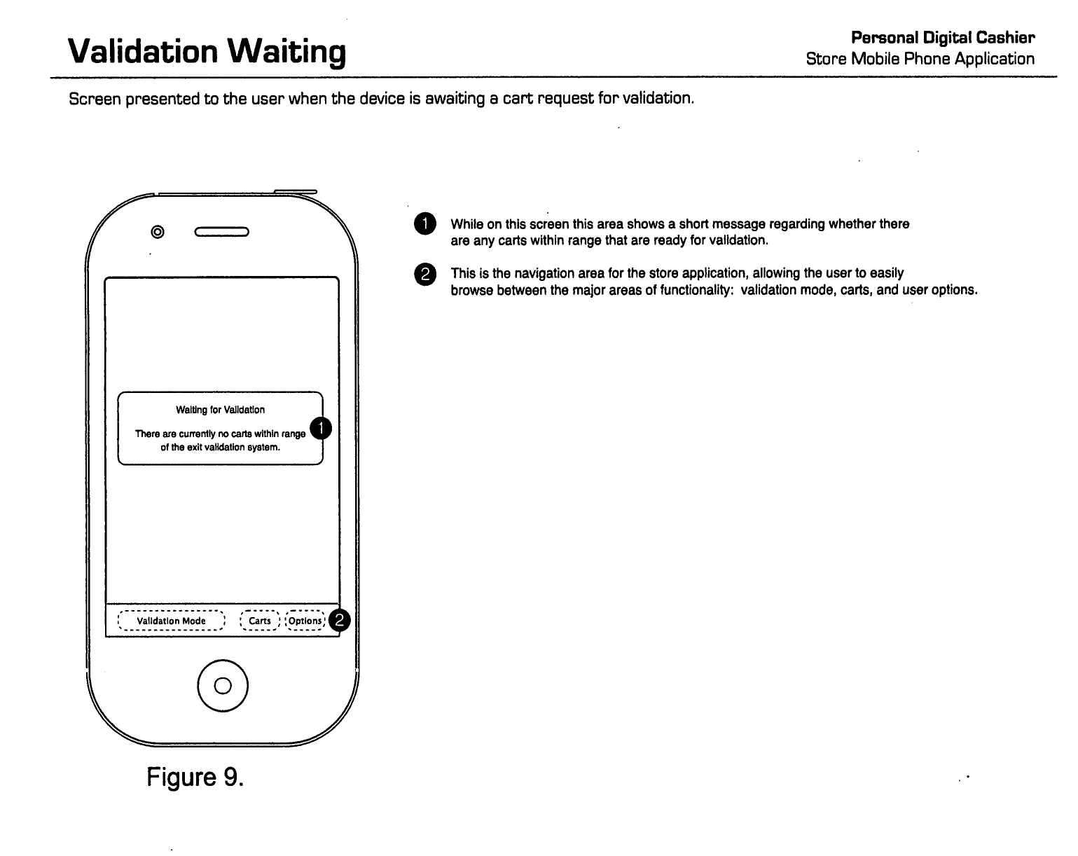

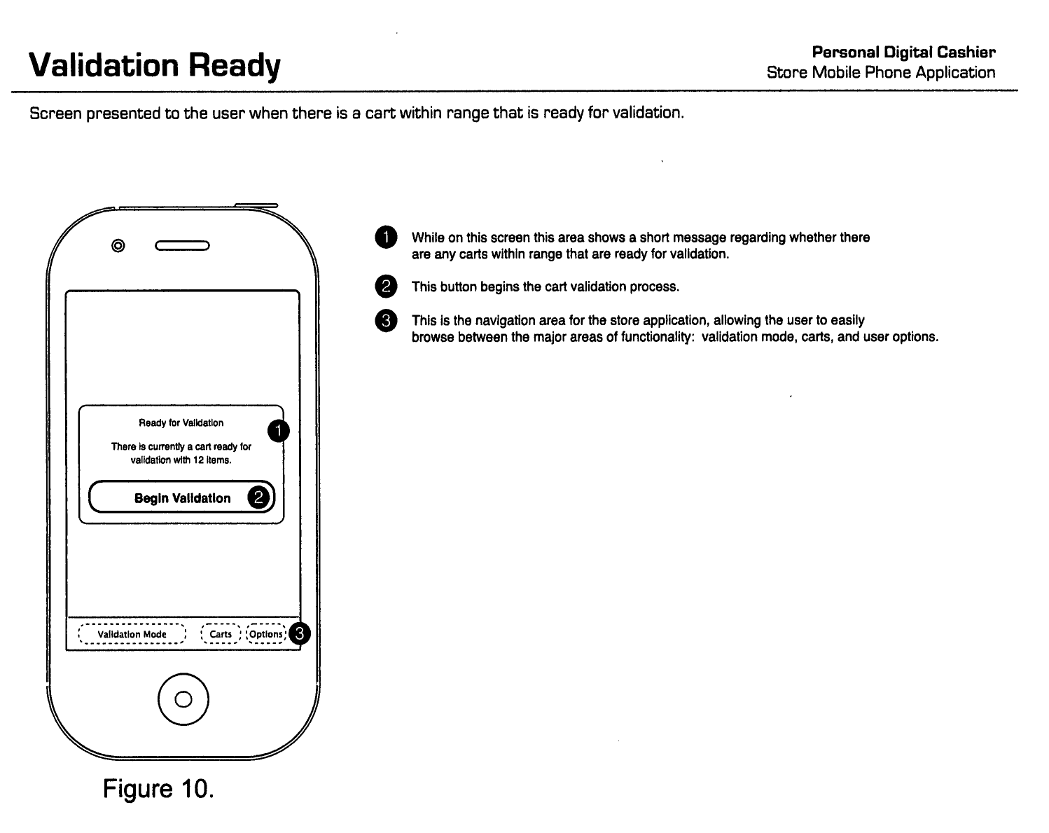

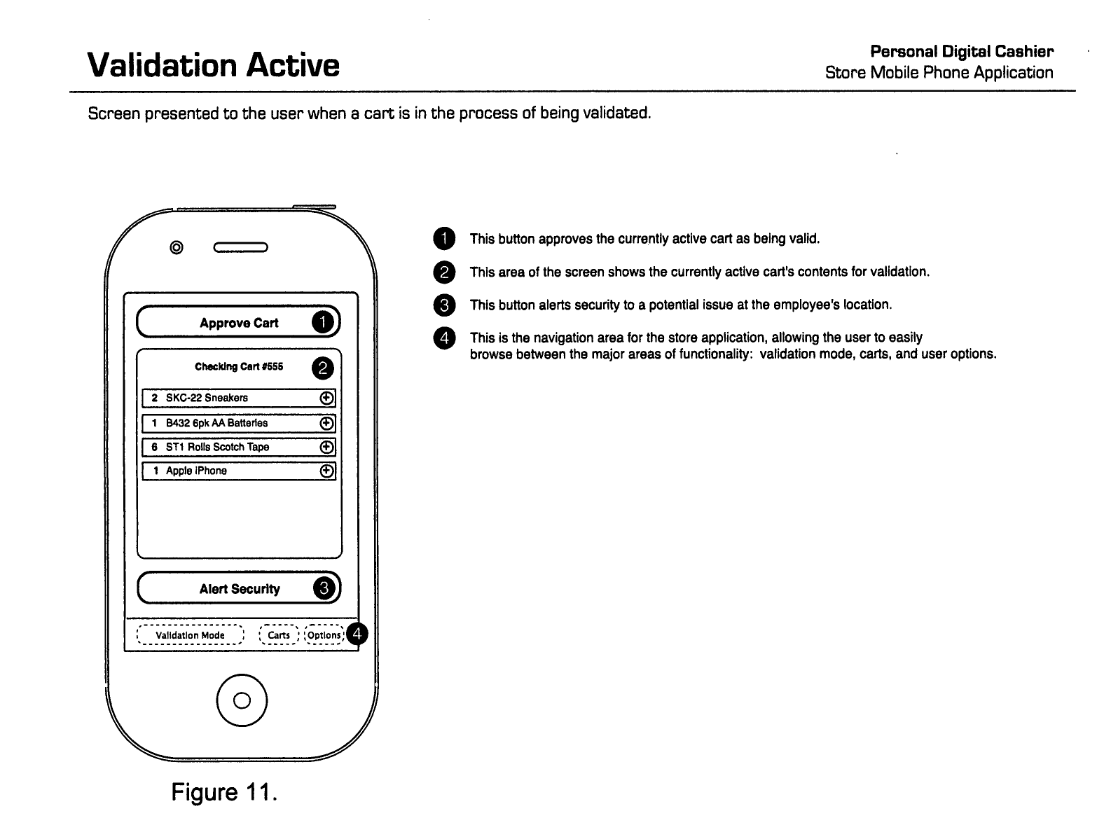

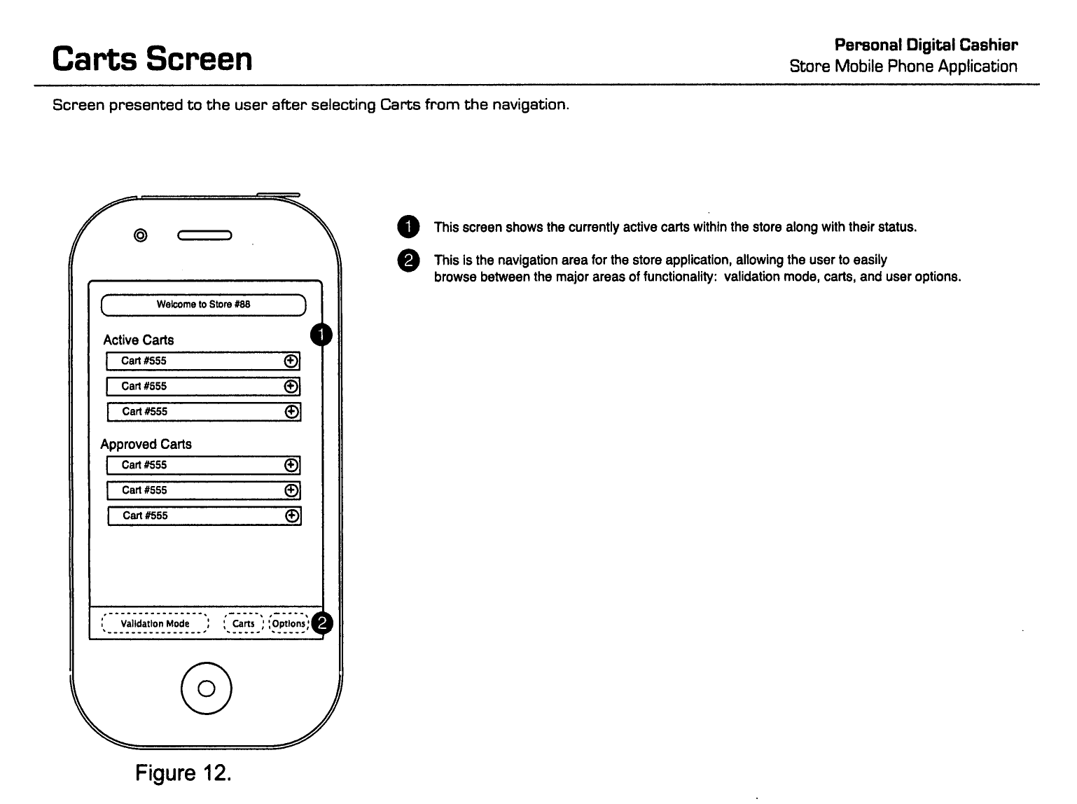

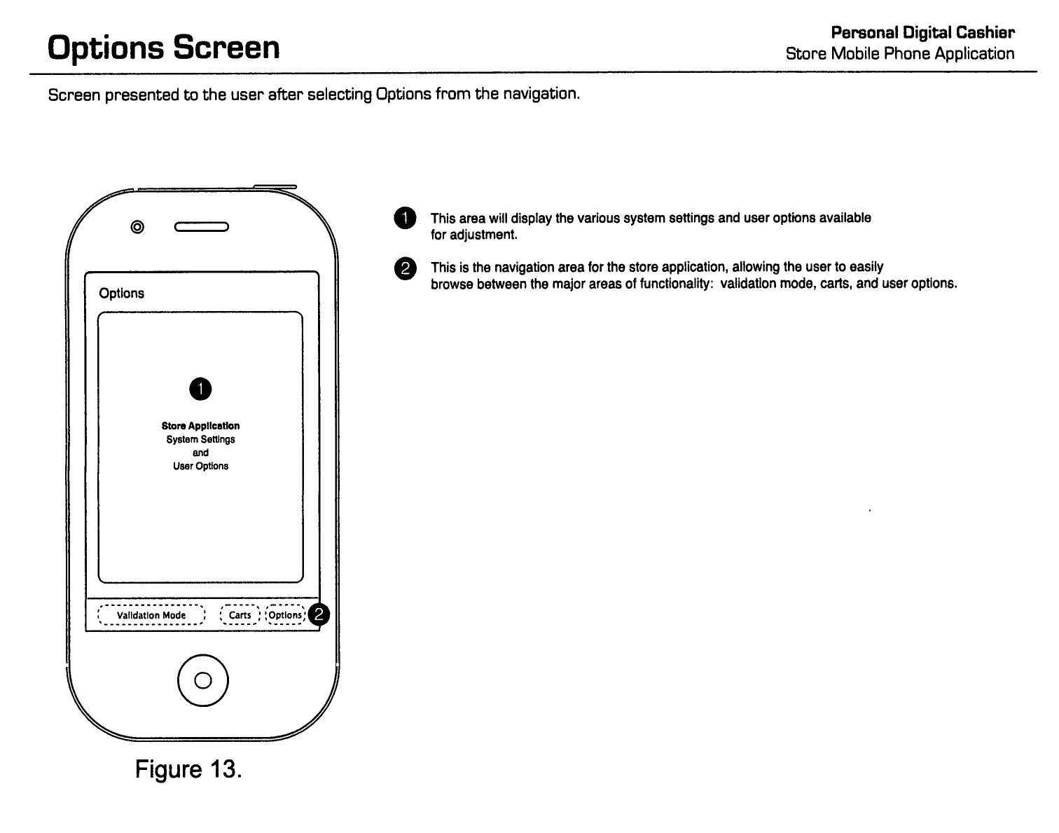

FIG. 1 illustrates the screen seen by the shopper the first time that the system is activated. If the shopper desires, they can view a tutorial of the system to become more familiar with how it operates before they begin using the system. If the shopper does not desire to view a tutorial, they can choose to skip the tutorial and begin using the system immediately. The navigation buttons at the bottom of the screen are present throughout FIGS. 1 through 7.

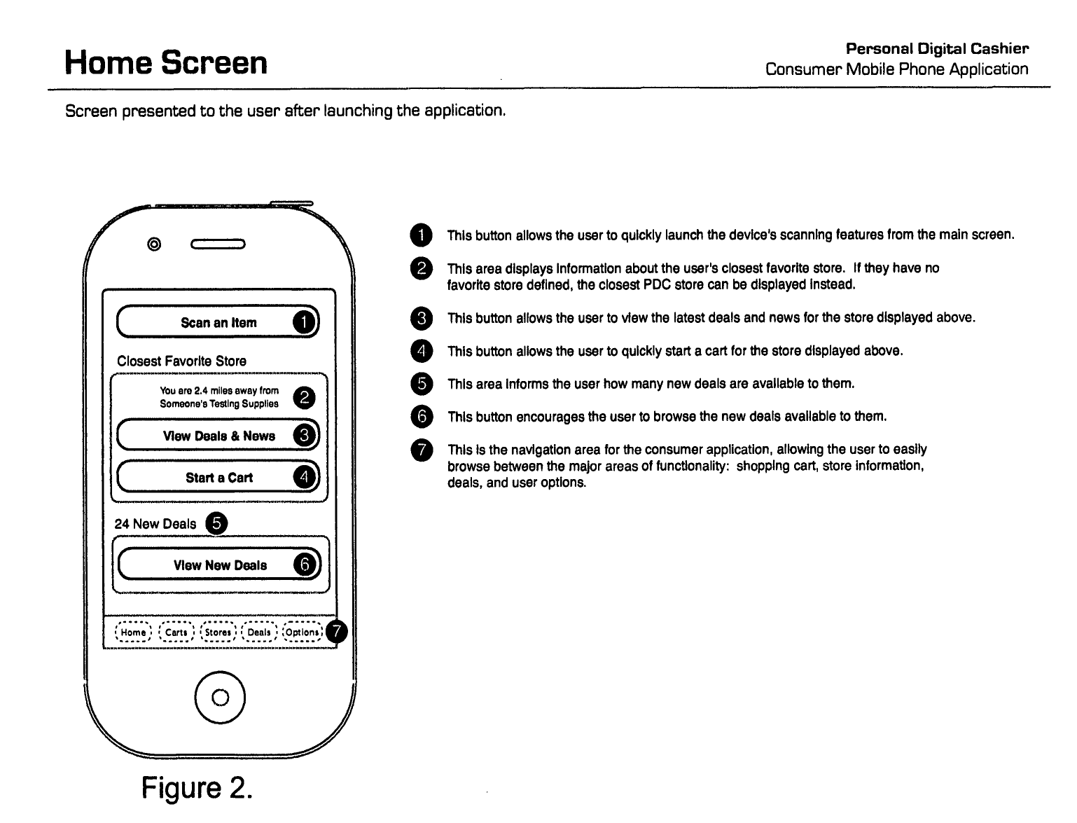

The shoppers' main menu screen is seen in FIG. 2, wherein the shopper can choose to from a variety of options related to their closest/favorite store or view the latest deals available.

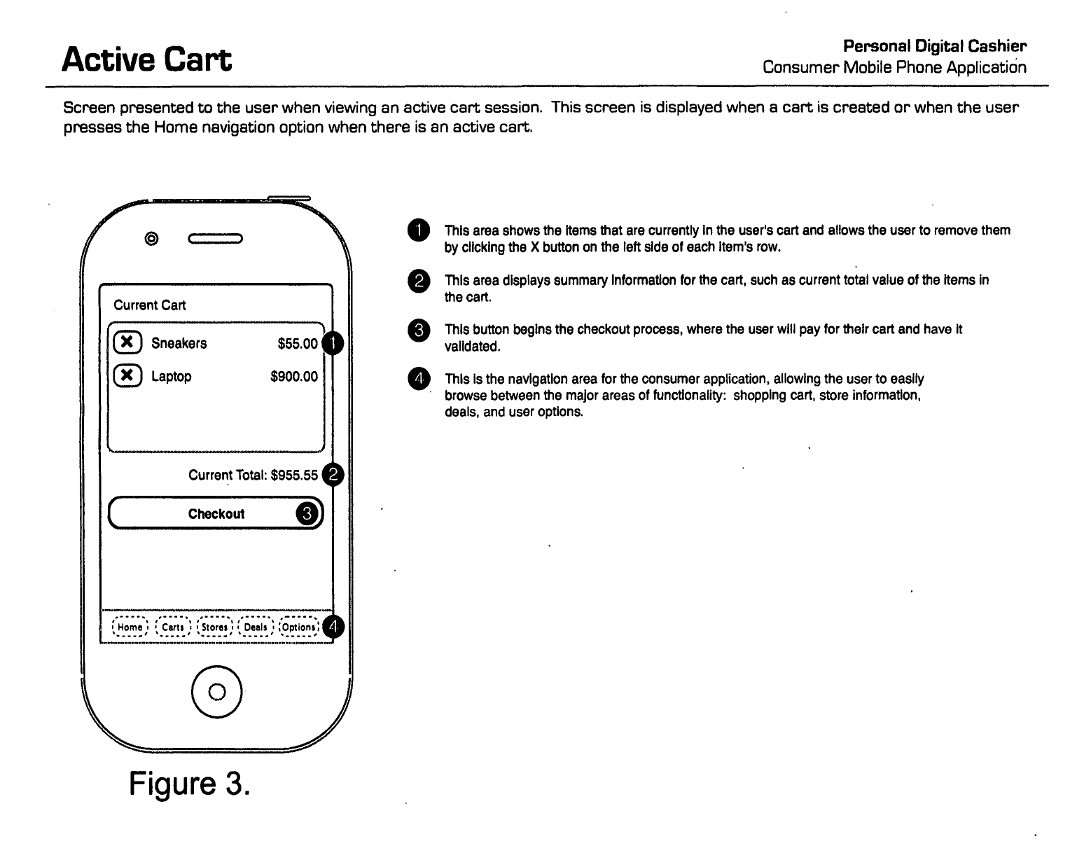

If the shopper desires to begin a new shopping session at their favorite store, they would select the start a cart option and begin shopping. While shopping, the active cart screen from FIG. 3 is seen. The active cart screen shows the items currently in their cart along with the item prices and the current total cost of all items in the shopping cart. Once the shopper has completed their shopping list, the checkout option can be selected to complete payment for the items in the cart.

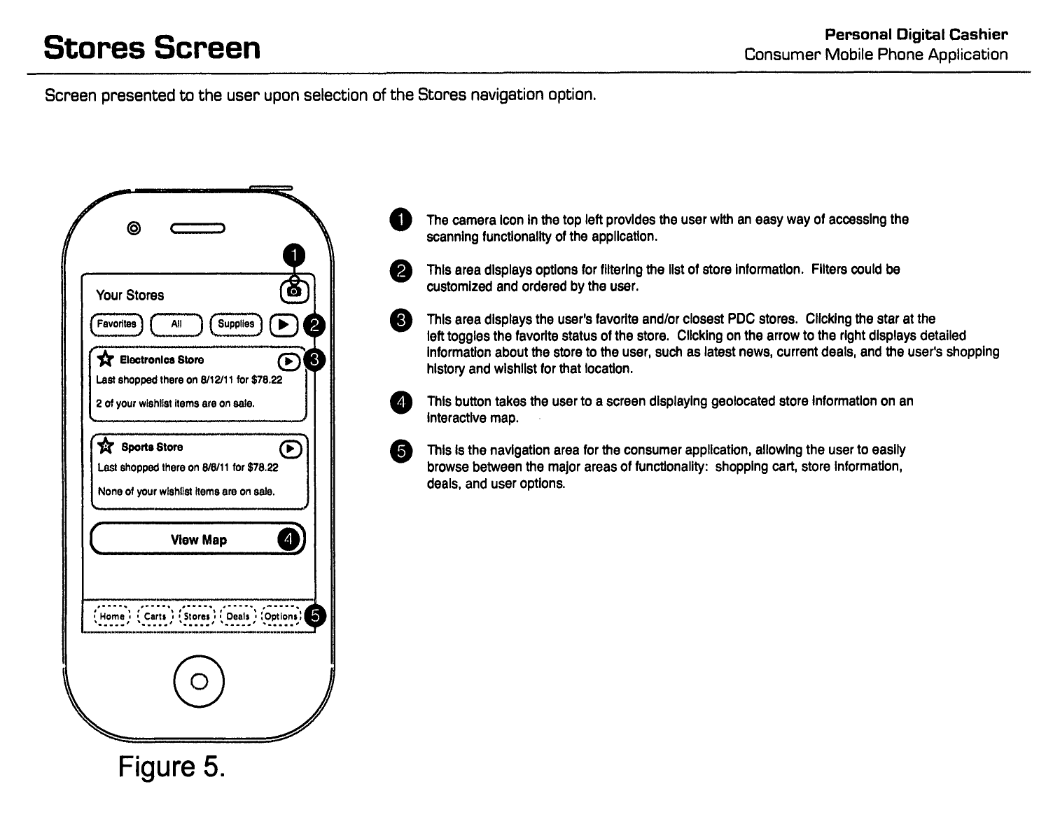

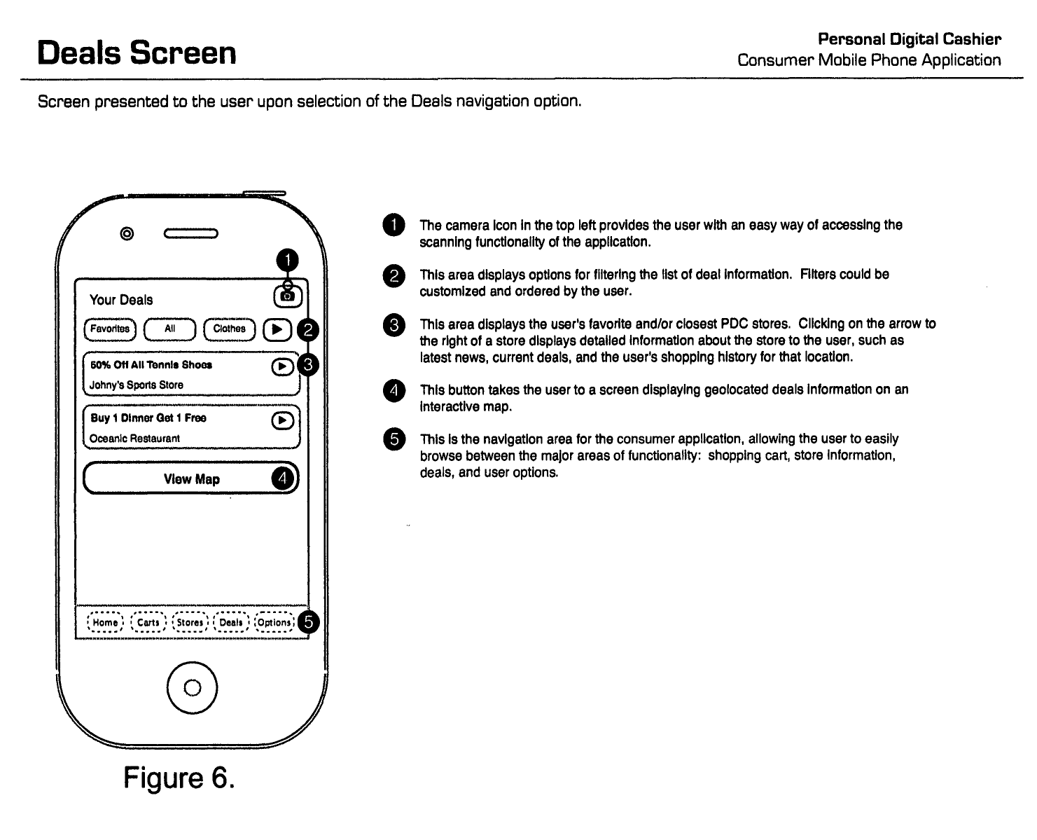

FIG. 6 illustrates the several ways the shopper has to manage their shopping experience; including selecting which stores they will visit by first reviewing the available deals from each of the stores. Once all of the deals have been reviewed, the shopper can visit the stores with the deals they selected. FIG. 5 illustrates the option to view the items and deals available at their favorite or closest stores, or to view a map of the stores with geolocated store information.

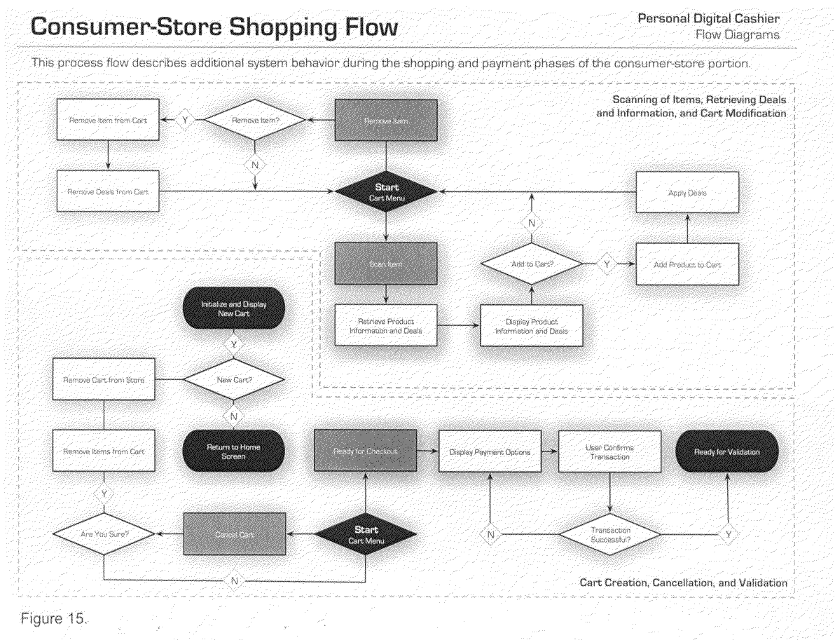

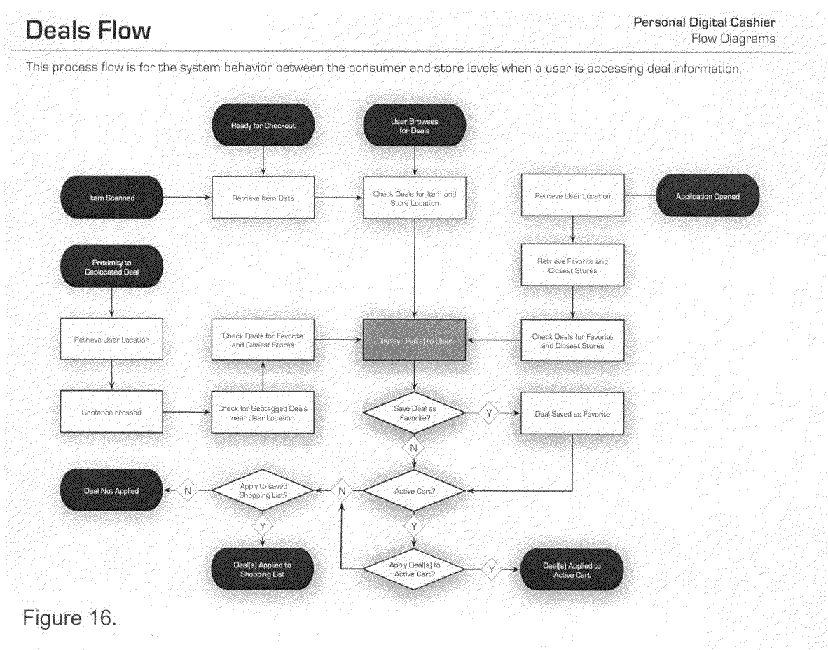

FIG. 15 displays the system processes for adding and removing items from the shopping cart, as well as the processes that occur in preparing for and completing payment and validation of the shoppers cart.

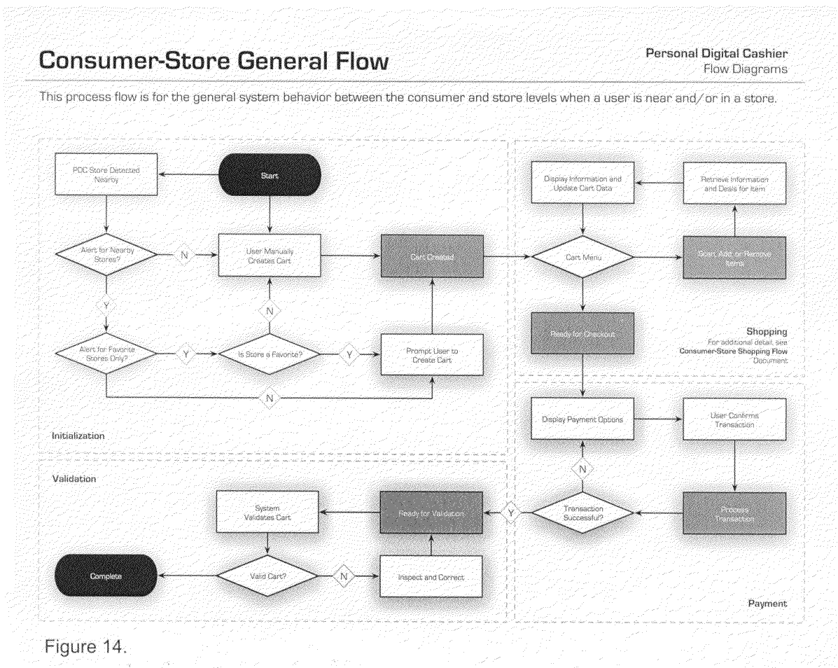

FIG. 14 shows the system process flow from the time the system starts through either a store being detected nearby or the shopper opening a new cart, all the way through the shopping process, to payment for the items placed in the cart, and finally validation of the shopping cart by the store.

FIG. 15 shows the system behavior during the shopping and payment portion of the shopping process.

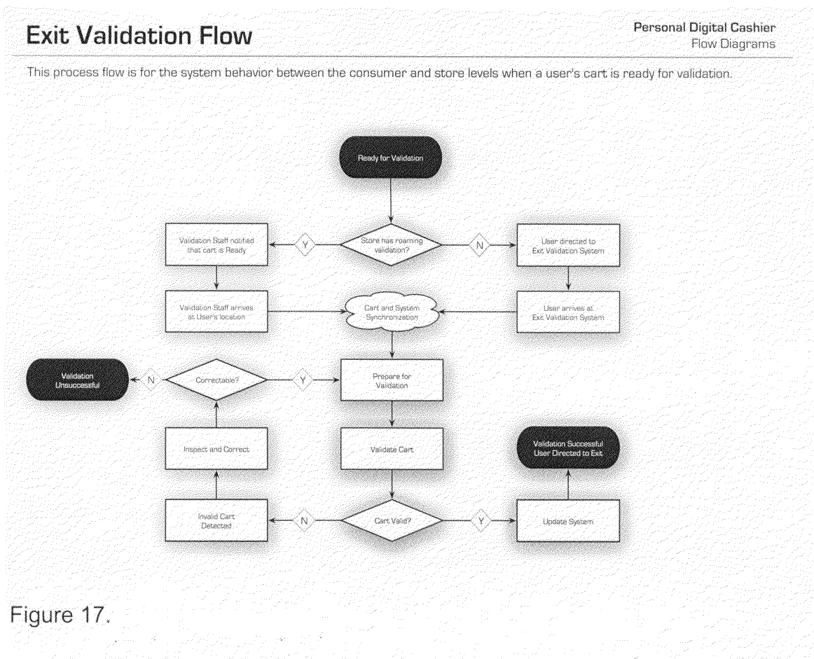

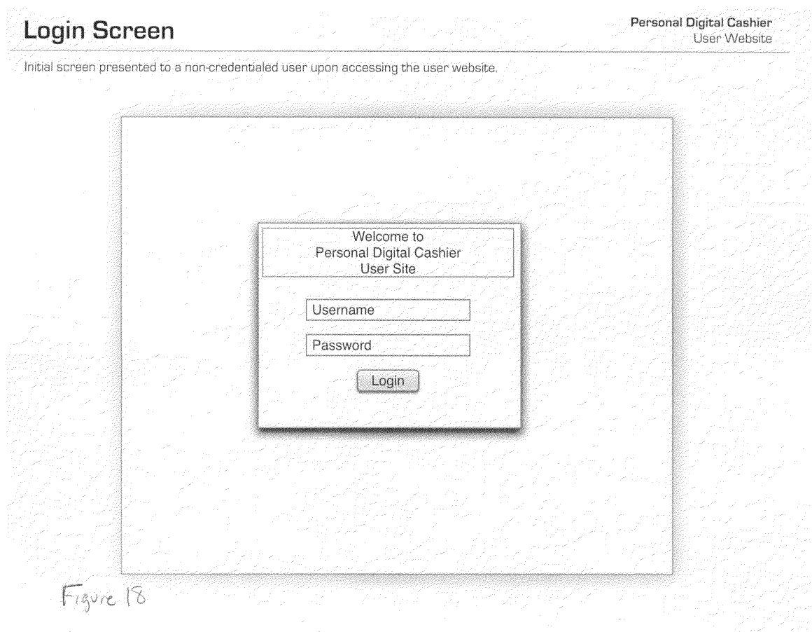

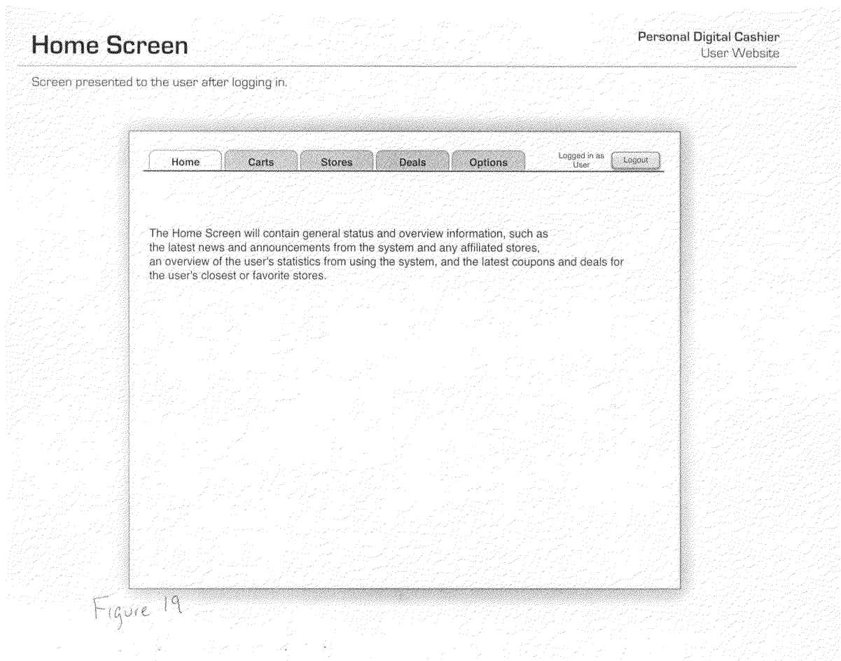

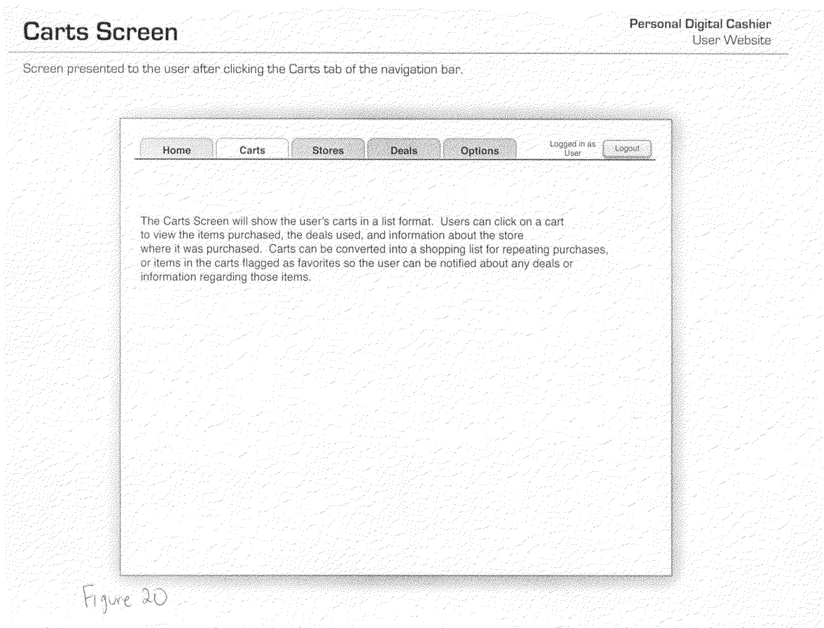

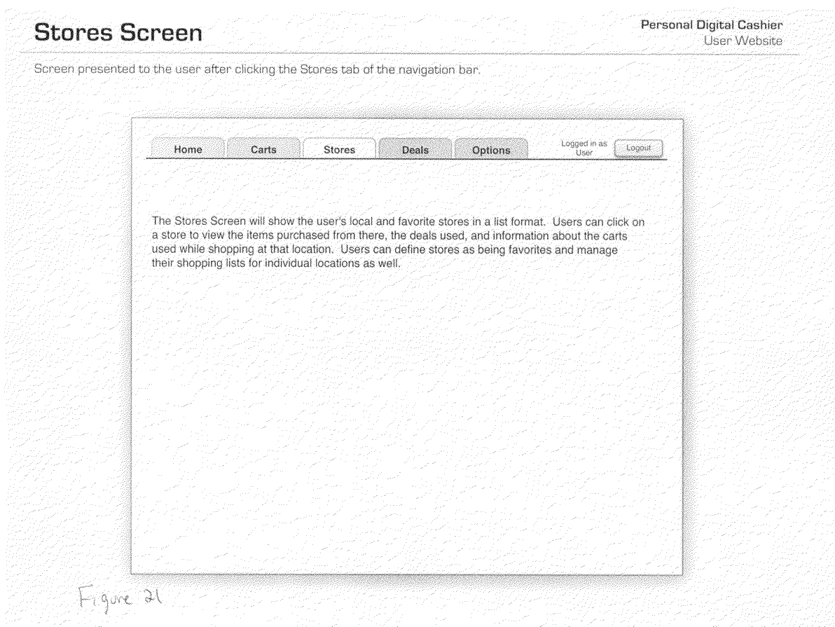

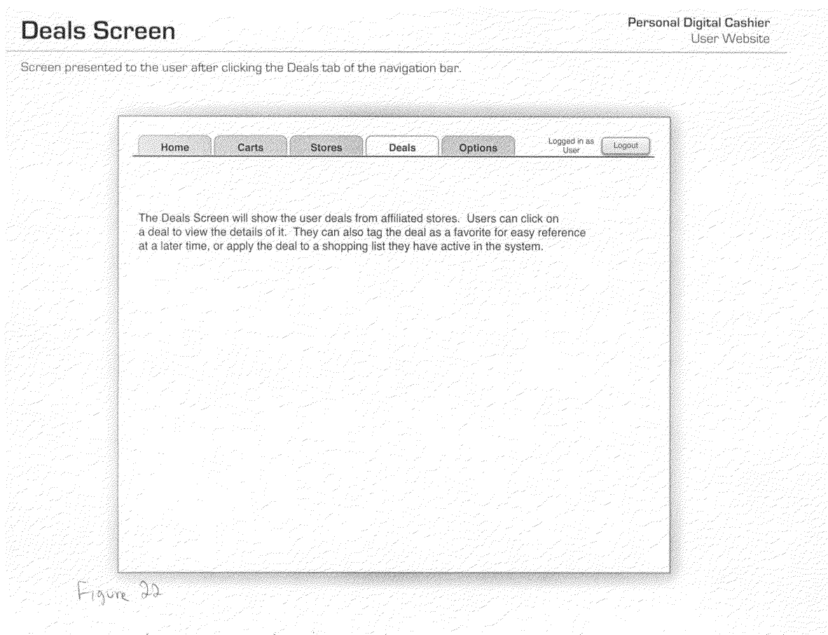

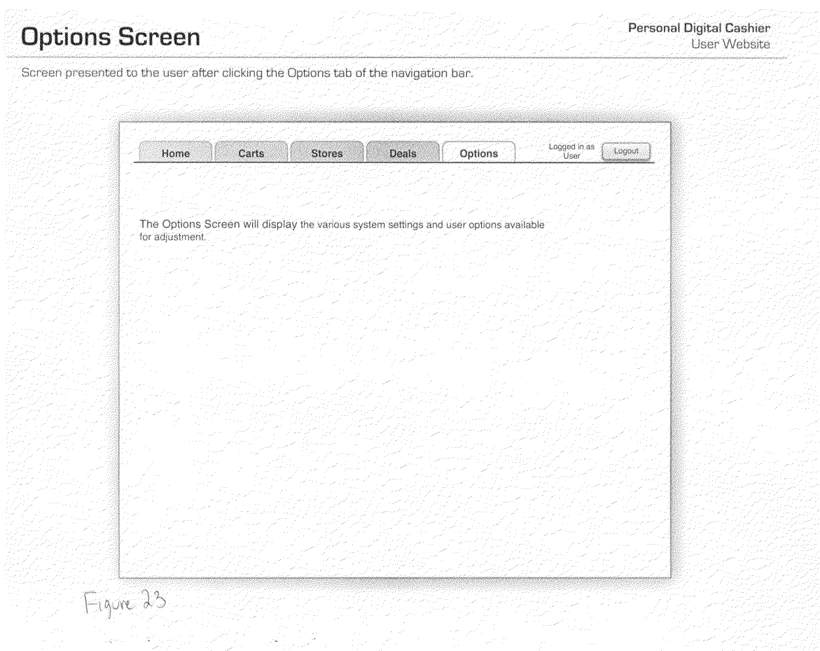

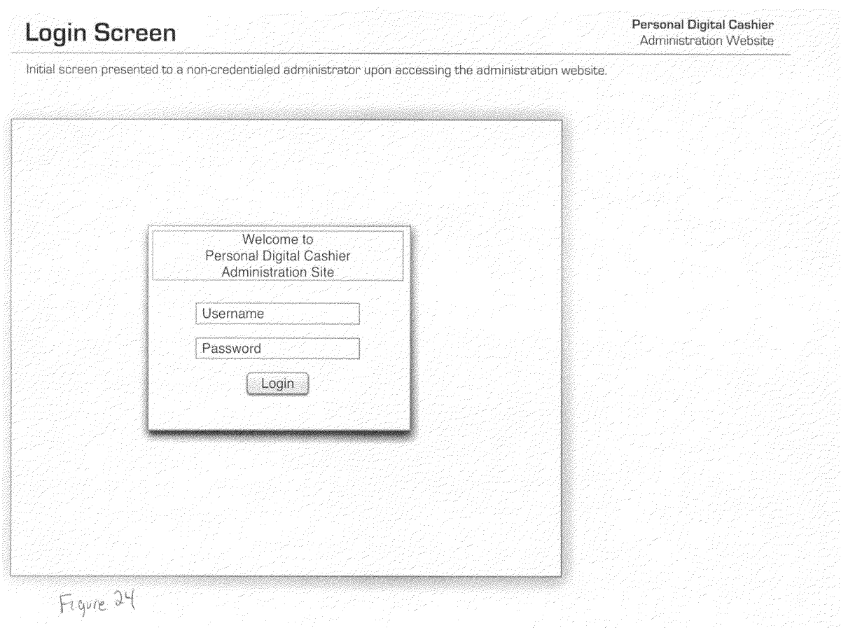

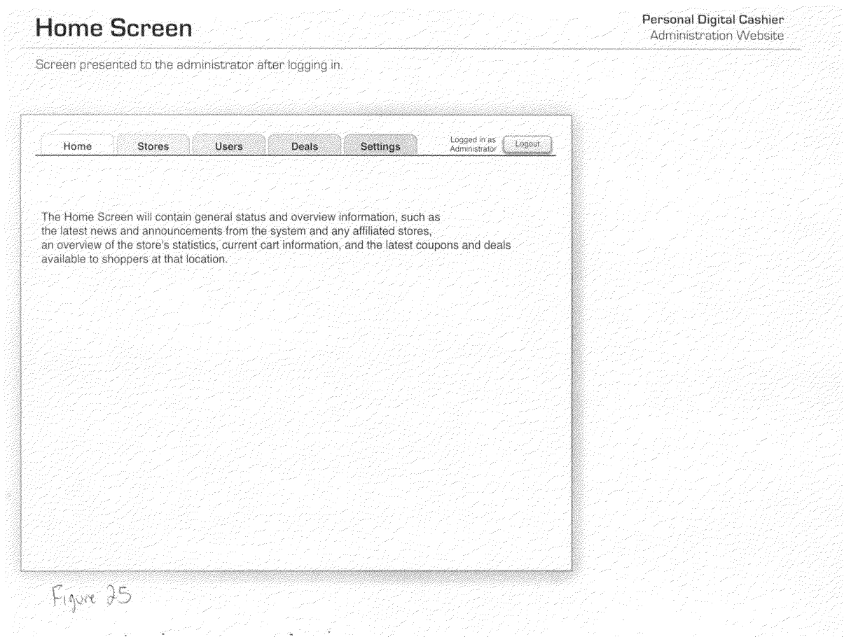

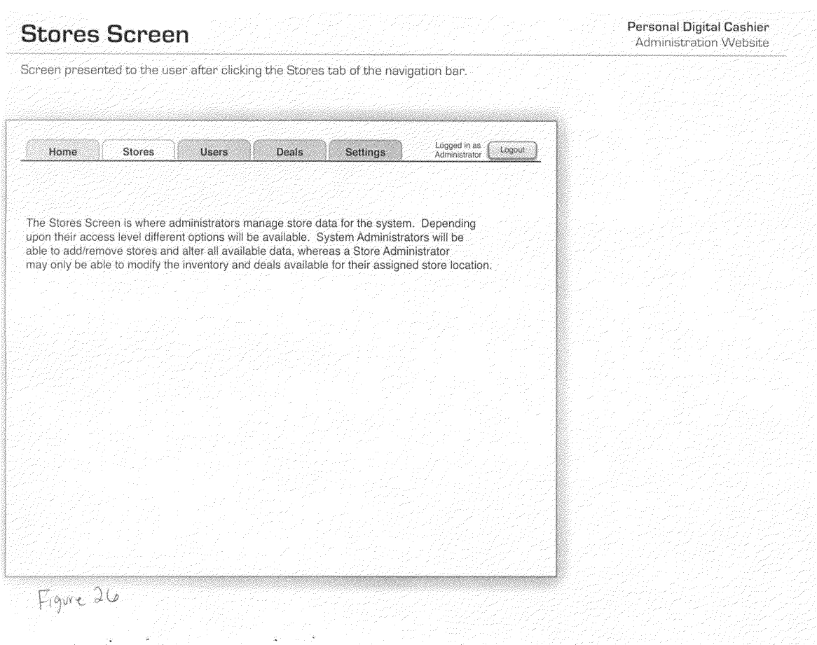

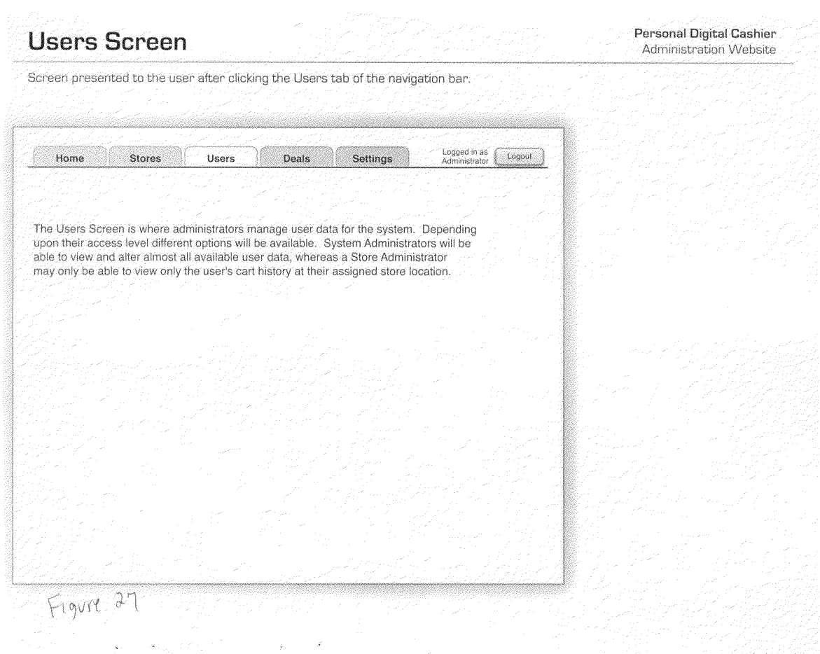

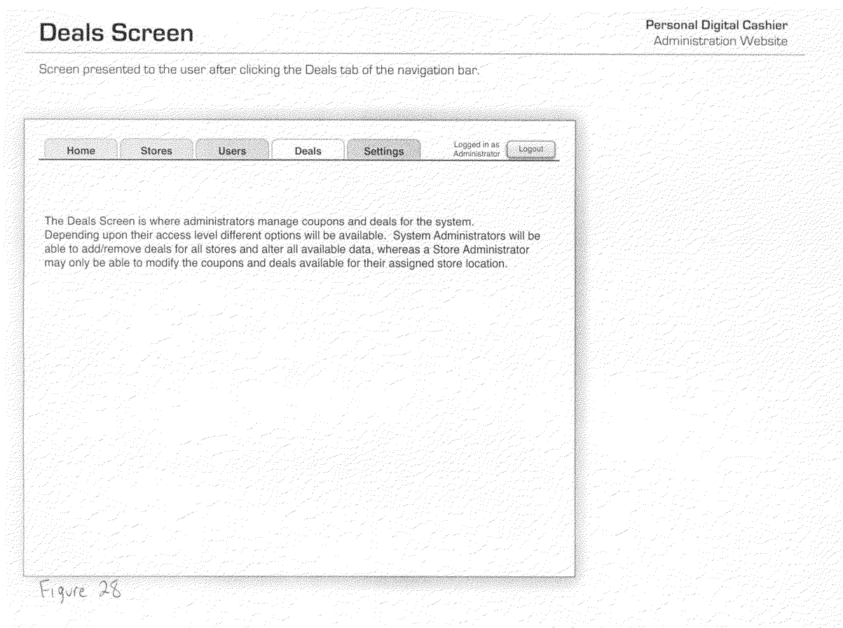

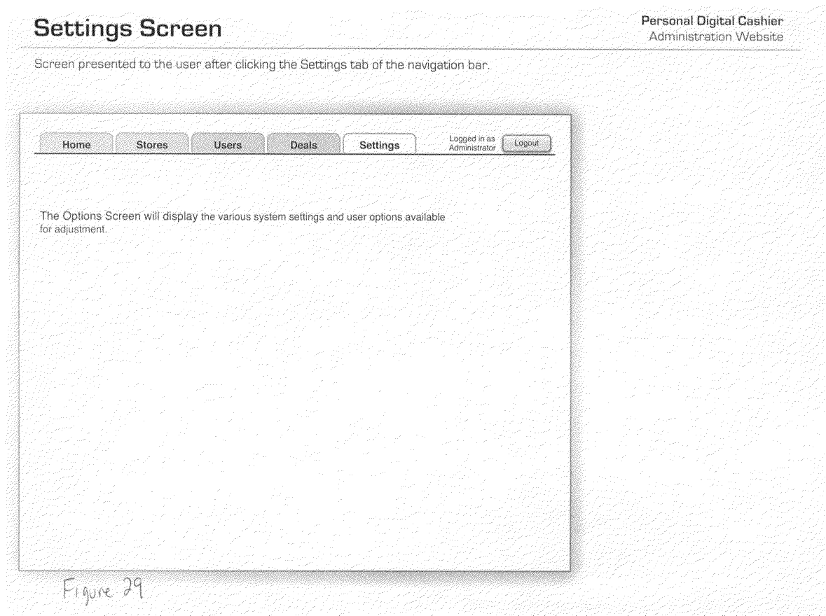

FIG. 17 displays the interaction process between the shopper and the retail stores' system when the shoppers cart is ready to be validated.

We Claim:

1. A system and method for discount location and coupon redemption in completing cashierless purchase transactions from a retail merchant, comprising:
a) providing a shopper selectable mobile application to be installed on a mobile device;
b) accessing the geo-location capabilities of said mobile device for determination of the best deals and relevant coupons in a shoppers preferred shopping range;
c) providing an input means for the shopper to select desired items for purchase;
d) providing a selection means for finalizing list of desired items to purchase;
e) providing a selection means for completing the purchase transaction; and
f) providing a means of confirming payment to the retail merchant.

2. The system and method of claim 1 wherein said mobile device is a smart device or smart phone.

3. The system and method of claim 1 wherein the input means comprises a bar code scanner, an RFID scanner, near field communication technology, a touch screen, a camera, or any combination thereof.

4. The system and method of claim 1 wherein the selection means comprises a touch screen operated menu or keyboard entry.

5. The system and method of claim 1 wherein the means of confirming payment comprises validation of the shopper's payment and synchronization of the merchant's inventory and accounting systems.

6. The system and method of claim 1 further comprising providing a website for internet based access to the shoppers account and enabling the shopper to complete purchase transactions from online merchants, and enabling the shopper to complete purchase transactions when access to a mobile device is unavailable.

7. A mobile device implemented electronic shopping system for providing coupon location and retail purchase transaction functionality to ensure that available discounts and coupons are used and subtracted from purchase total before a cashierless purchase transaction with a retail merchant is completed, comprising:
a) providing a means for receiving a shopper's information and preferences;
b) providing an input means for adding items to the shoppers shopping cart;
c) providing a discount and coupon locating means for obtaining the best available pricing on the shoppers desired items;
d) providing a payment means to the merchant; and
e) receiving a confirmation of payment from the merchant.

8. The mobile device implemented electronic shopping system of claim 7 wherein the means for receiving a shopper's information and preferences includes a touch screen keyboard.

9. The mobile device implemented electronic shopping system of claim 7 wherein the input means comprises a scanner, keyboard, camera, Bluetooth technology, near field communication technology, RFID technology, local area network (LAN), wide area network (WAN), or any combination thereof

10. The mobile device implemented electronic shopping system of claim 7 wherein the discount and coupon locating means comprises geolocation software used in conjunction with discount and coupon databases.

11. The mobile device implemented electronic shopping system of claim 7 further comprising a means for displaying payment receipt and payment confirmation code from merchant.

12. The mobile device implemented electronic shopping system of claim 11 wherein said payment confirmation code is used to deactivate anti-theft devices and RFID tags associated with the items purchased.

13. A mobile device implemented software process for locating the best deals, discounts and coupons in a shoppers area and allowing the shopper to purchase their selected items from a retail merchant without waiting in line to checkout, comprising:
a) providing a means for displaying one or more shopper selectable menus;
b) providing an input means for receiving inputs of shopper selected items for purchase;
c) providing a communication means for interacting with the geolocating means of said mobile device to obtain available discounts and coupons for selected items;
d) providing a payment means for completing a secured purchase transaction with the merchant; and
e) receiving the confirmation of payment receipt from said merchant.

14. The mobile device implemented software process of claim 13 further comprising a means for confirming deactivation of RFID tags or other anti-theft mechanisms associated with the purchased items.

15. The mobile device implemented software process of claim 13 further comprising providing an integrated payment means for completing the purchase transaction without involving a third party payment system.

16. A mobile device implemented system and method for cashierless retail shopping, comprising:
a) accepting the shoppers input of desired purchase items;
b) accepting geolocated discounts and coupons for desired purchase items;
c) providing the shopper all available payment options;
d) accepting the shoppers payment selection; and
e) providing payment confirmation to a merchant.

17. The mobile device implemented method of claim 16, wherein all available payment options includes providing the shopper the ability to complete the purchase transaction securely from their associated personal digital cashier account.

18. The mobile device implemented method of claim 16, further comprising:
providing a validation request to the merchant's inventory and accounting system.

19. The mobile device implemented method of claim 16, further comprising:
receiving an acknowledgement of payment receipt and deactivation of anti-theft systems for the purchased items from the merchant.

20. The mobile device implemented method of claim 16, further comprising;
providing an internet based website to allow shoppers to access their account and shop electronically when away from their mobile device.
